(19) United States
(12) Patent Application Publication
(10) Pub. No.: US 2025/0371419 A1
(43) Pub. Date: Dec. 4, 2025

(54) OPTIMAL MULTICORE OPTIMIZATION FOR MACHINE LEARNING MODEL GENERATION

(71) Applicant: STMicroelectronics International N.V., Geneva (CH)

(72) Inventors: He Huang, Paris (FR); Basile Wolfrom, La Garde (FR)

(21) Appl. No.: 19/189,800

(22) Filed: Apr. 25, 2025

(30) Foreign Application Priority Data
May 31, 2024 (FR) FR2405678

(51) Int. Cl. G06N 20/00; H04L 9/32

(52) U.S. Cl. CPC G06N 20/00; H04L 9/3236

(57) ABSTRACT

According to an embodiment, a method is proposed carried out by a computer system for tuning hyperparameters in a machine learning model, the computer system having a processing unit designed to execute a plurality of processes in parallel. The method comprising executing a plurality of independent hyperparameter search methods in different parallel processes of the processing unit, the results of the tests of the combinations of hyperparameters being stored in a memory in the computer system shared among the various processes, and wherein each process assesses whether a combination of hyperparameters searched for has already been tested by another process based on the results of tests stored in memory, and takes into account, in its own test history, the results of tests stored in the memory if the combination of hyperparameters searched for has already been tested.

### CROSS-REFERENCE TO RELATED APPLICATIONS

This application claims Priority to French Application No. 2405678, filed on May 31, 2024, which application is hereby incorporated by reference herein in its entirety.

### TECHNICAL FIELD

Embodiments and implementations relate to tuning hyperparameters in machine learning models.

### BACKGROUND

Hyperparameters are parameters used to control the training of a machine learning model. The value of the hyperparameters generally impacts the performance and effectiveness of the machine learning model. It is, therefore, advantageous to set the value of the hyperparameters to optimize the machine learning model's performance.

Tuning hyperparameters can also be referred to as "hyperparameter optimization". Hyperparameters are tuned by searching for a combination of hyperparameters that improves and, in particular, optimizes the performance of the machine learning model. The purpose of tuning hyperparameters is to search for a value for each hyperparameter of the learning model that improves the machine learning model's performance.

Hyperparameters can be used, for example, to define possible configurations for the machine learning model and the algorithms used by the machine learning model. The search for the combination of hyperparameters is carried out in a search space containing all of the possible configurations and algorithms that can be used.

### SUMMARY

For example, tuning hyperparameters in a machine learning model can comprise setting a learning rate, a number of layers/neurons in a neural network, a decision tree depth in a random forest, the use or not of data processing methods in part of the learning model (for example, the use of Fast Fourier Transform or FFT for short or specific filters for processing time series), etc. Hyperparameter tuning can be carried out by means of a grid search or a random search in the search space, for example.

Tuning hyperparameters in a machine learning model can be time-consuming because the search for a combination of hyperparameters is carried out in a high-dimensional non-linear search space, particularly when the machine learning model is complex and involves many variables and algorithms. In addition, the search for hyperparameters may be inadequate for sufficiently exploring the search space in a limited time. Therefore, tuning hyperparameters in a machine learning model may act as a brake on developing and rolling out machine learning models.

Therefore, there is a need to propose a solution to improve hyperparameter tuning for a machine learning model.

According to one aspect, a method is proposed, carried out by a computer system, for tuning hyperparameters in a machine learning model, the computer system having a processing unit designed to execute a plurality of processes in parallel, the method comprising executing a plurality of independent hyperparameter search methods in different parallel processes of the processing unit, each independent search method being designed to progressively test different combinations of hyperparameters and being configured to keep a history of each test, the results of the tests of the combinations of hyperparameters being stored in a memory in the computer system shared among the various processes, and wherein each process, before testing a combination of hyperparameters, assesses whether this combination of hyperparameters has already been tested by another process based on the results of tests stored in memory, and takes into account, in its own test history, the results of tests stored in the memory if the combination of hyperparameters has already been tested.

Each combination of hyperparameter defines each hyperparameter's value in the machine learning model.

Such a method makes it possible to execute a plurality of independent search methods simultaneously by sharing the results of the performance tests obtained by each search method. This makes it possible to improve the effectiveness and speed of hyperparameter tuning, avoiding duplicate testing of the combinations of hyperparameters whilst considering the results of the combinations of hyperparameters already tested for each search method. Executing the various independent search methods in parallel in various processes also makes it possible to search for a greater number of combinations of hyperparameters in a given period. Using a plurality of independent search methods improves the exploration of the search space.

Carrying out a plurality of search methods improves the exploration of the various combinations of hyperparameters in the search space.

Such a method, therefore, improves the results of hyperparameter tuning in a shorter period, thereby improving the development and roll-out of machine learning models.

Advantageously, the method also comprises executing a global hyperparameter search method in an additional process in parallel with executing the independent hyperparameter search methods, the global search method being designed to progressively test different combinations of hyperparameters and being configured to keep a history of each test, the results of the tests of the combinations of hyperparameters being stored in the shared memory, the global search method being designed to take into account all the results of the tests stored in the shared memory to define a new combination of hyperparameters to test.

The global search method facilitates the search for a global optimum combination of hyperparameters by considering the results of the tests carried out by all the independent search methods as well as those carried out by this global search method.

In one advantageous embodiment, the processing unit comprises a plurality of processing cores, the processes being executed by the various processing cores to carry out the various hyperparameter search methods.

Preferably, each search method for a combination of hyperparameters has an initial step of defining an initial combination of hyperparameters, this initial combination of hyperparameters being defined randomly for at least one search method.

One of the independent hyperparameter search methods is advantageously a random search method.

In one advantageous embodiment, a grid search method is one of the independent hyperparameter search methods.

In embodiments, one of the independent hyperparameter search methods is an adaptive search method designed to consider the results of tests of its history to determine a new combination of hyperparameters to test.

Advantageously, the global hyperparameter search method is an adaptive search method designed to consider all of the results of the tests stored in the shared memory to determine a new combination of hyperparameters to test.

In one embodiment, the results of each hyperparameter combination test are stored in the shared memory with an identifier, this identifier calculated based on the combination of hyperparameters associated with this test. In addition, before testing a new combination of hyperparameters, each process calculates an identifier based on this new combination of hyperparameters and compares this identifier with the identifiers of the results of the tests stored in memory, and determines that the new combination of hyperparameters has already been tested by another process if the identifier of this new combination of hyperparameters corresponds to an identifier stored in the shared memory.

The identifier of a combination of hyperparameters is advantageously calculated by applying a hash function to this combination of hyperparameters.

According to another aspect, an information system is proposed comprising: a processing unit designed to execute a plurality of processes in parallel, a shared memory among the various processes, and wherein the processing unit is designed to execute a plurality of independent hyperparameter search methods in different parallel processes of the processing unit, each independent search method being designed to progressively test different combinations of hyperparameters and to keep a history of each test, the results of the tests of the combinations of hyperparameters being stored in a memory in the computer system shared among the various processes, each process being designed to, before testing a combination of hyperparameters, assess whether this combination of hyperparameters has already been tested by another process based on the results of tests stored in memory, take into account, in its own test history, the results of tests stored in the memory if the combination of hyperparameters has already been tested.

In one embodiment, the processing unit is also designed to execute a global hyperparameter search method in an additional process in parallel with executing the independent hyperparameter search methods, the global search method being designed to progressively test different combinations of hyperparameters and being configured to keep a history of each test, the results of the tests of the combinations of hyperparameters being stored in the shared memory, the global search method being designed to take into account all the results of the tests stored in the shared memory to define a new combination of hyperparameters to test.

The processing unit preferably comprises a plurality of processing cores, the various processing cores being designed to execute the processes to carry out the various hyperparameter search methods.

The shared memory is preferably designed to store the results of each hyperparameter combination test with an identifier. In addition, the processing unit is designed to calculate this identifier based on the combination of hyperparameters associated with this test. Before testing a new combination of hyperparameters, each process is designed to calculate an identifier based on this new combination of hyperparameters and to compare this identifier with the identifiers of the results of the tests stored in memory, and to determine that the new combination of hyperparameters has already been tested by another process if the identifier of this new combination of hyperparameters corresponds to an identifier stored in the shared memory.

The processing unit is advantageously designed to calculate the identifier of a combination of hyperparameters by applying a hash function to this combination of hyperparameters.

According to another aspect, a computer program product is proposed comprising instructions which, when the program is executed by a computer system comprising a processing unit designed to execute a plurality of processes in parallel and a shared memory among the various processes, cause the computer system to carry out a method for tuning hyperparameters in a machine learning model as described above.

### BRIEF DESCRIPTION OF THE DRAWINGS

Other advantages and features of the invention will become apparent upon reading the detailed description of embodiments, which are in no way limiting, and from the appended drawings in which:

FIG. 1 is a block diagram of an embodiment computer system to carry out a method for tuning hyperparameters in a machine learning model; and

FIG. 2 is a flowchart of an embodiment method for tuning hyperparameters in a machine learning model.

### DETAILED DESCRIPTION OF ILLUSTRATIVE EMBODIMENTS

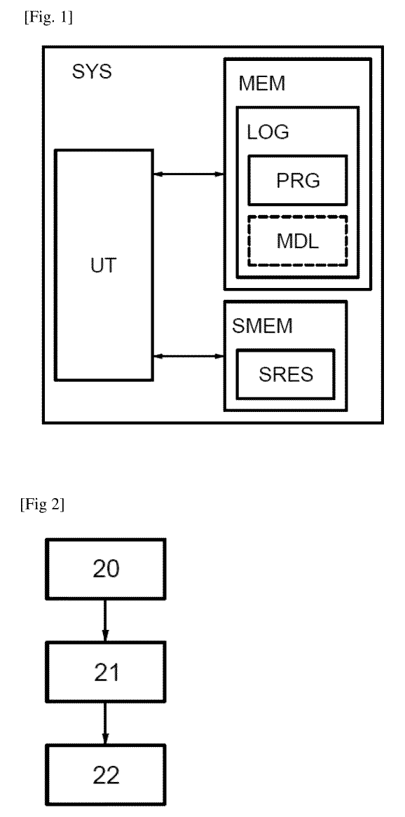

FIG. 1 illustrates a block diagram of an embodiment computer system (SYS) designed to conduct a method for tuning hyperparameters in a machine learning model, as described below concerning FIG. 2.

The computer system (SYS) comprises a processing unit (UT) and a memory (MEM). Such a computer system (SYS) can be a personal computer or a server, for example.

The processing unit (UT) is designed to execute a plurality of processes simultaneously. For example, the processing unit (UT) has a processing core designed to execute a plurality of processes simultaneously, particularly a plurality of threads. Alternatively, or in combination, the processing unit (UT) has a plurality of processing cores to execute a plurality of processes simultaneously. Executing a plurality of processes simultaneously improves the efficiency of process handling.

The memory (MEM) has a software (LOG) for developing machine learning models. This software can be run by the processing unit (UT).

The software (LOG) can offer the user the opportunity to carry out projects to develop machine learning models. A project is defined according to the application targeted by the machine learning model to be developed. For example, a project can involve anomaly detection, classification into one or more classes, and extrapolation. Various types of machine learning models can be studied for each targeted application. Each machine learning model has its hyperparameters.

In a project, the software (LOG) enables the user to provide at least one training data file. Each training data file can, for example, correspond to a set of time-series signals.

The software is also designed to enable the user to carry out at least one benchmark for a project. A benchmark is used to develop a machine learning model based on training data chosen by the user and to assess the performance of this machine learning model. For example, the user provides the training data file(s) that they have previously supplied for this project.

Using a plurality of benchmarks enables the user to test different training datasets for the different benchmarks. In this way, the user can obtain a machine learning model for each benchmark and compare the performance of each of these machine learning models.

For each benchmark, the software (LOG) is designed to develop at least one type of machine learning model.

To develop a machine learning model, the software (LOG) is designed to tune the various hyperparameters of this machine learning model. In other words, the software (LOG) is designed to identify values for the hyperparameters of the machine learning model that are suitable for improving the performance of the machine learning model.

In particular, for each benchmark, the processing unit is designed to execute a computer program (PRG) of the software (LOG) for developing machine learning models. The program (PRG) comprises instructions which, when the program (PRG) is executed by the processing unit (UT) of the computer system (SYS), cause it to carry out a method for tuning hyperparameters as described below.

The computer system (SYS) also comprises a shared memory (SMEM) designed for read and write access by the various processes of the processing unit (UT), in particular to store results RSES thereof hyperparameter combination tests, as described below.

FIG. 2 illustrates a flowchart of an embodiment method for tuning hyperparameters in a machine learning model. This can be carried out in a benchmark of the software (LOG) for developing machine learning models.

The method comprises step 20 of defining hyperparameter search methods. The hyperparameter search methods are suitable for searching for and testing combinations of hyperparameters. Each combination of hyperparameters searched for is tested by assessing the machine learning model's performance resulting from this combination of hyperparameters. Thus, each search method comprises defining a combination of hyperparameters and then assessing this combination of hyperparameters, this defining and this assessing being iterated several times to test different combinations of hyperparameters. Defining a combination of hyperparameters makes it possible to define a value for each hyperparameter in the machine learning model.

The machine learning model's performance is assessed after training the machine learning model. This training is carried out based on the training data used for the benchmark in which the method for tuning hyperparameters is carried out. The learning model's performance can, in particular, be assessed by cross-validation or by dividing the training data set into a reduced set of training data and a set of test data.

The assessed performance of the machine learning model comprises, for example, accuracy of the machine learning model, execution time of the machine learning mode, memory size for storing the machine learning model, and memory size for storing the data generated when the machine learning model is executed. In particular, a global performance score can be calculated to consider the overall performance of the machine learning model.

The hyperparameters are searched for in a search space. Discretization is performed on the search space to limit the number of hyperparameters that can be searched for in the search space. This discretization produces a finite number of points in the search space, spaced apart by a given step size. This step size is defined to reduce the risk of testing hyperparameters with close values that have similar performance.

The hyperparameters can be searched for by executing different search methods. A first search method is a grid search method. The grid search method is used to exhaustively test all of the combinations of hyperparameters in a zone of the search space.

A second search method is a random search method. The random search method is used to test combinations of hyperparameters randomly in the search space.

A third search method is an adaptive search method. The adaptive search method is designed to define each new combination of hyperparameters to be tested based on test results of hyperparameter combinations that have already been tested. For example, the adaptive search method can use an algorithm known as a Tree-structured Parzen Estimator or TPE for short.

The method comprises step 21 for initializing the hyperparameter search. In this initialization step, the processing unit (UT) defines an initial combination of hyperparameters to be tested for each search method. This initial combination of hyperparameters corresponds to a starting point in the search space.

It is possible to randomly define these initial combinations of hyperparameters, for example.

In one embodiment, some search methods are the same type (grid, random, adaptive search). In this case, using a different initial combination of hyperparameters for each search method of the same type means that the search space can be explored differently.

As seen above, a project can comprise a plurality of benchmarks. Each benchmark carries out the method for tuning hyperparameters. If a method for tuning hyperparameters has already been carried out previously, in particular, during a previous benchmark, it is possible to use the results of the tests carried out to define at least some initial combinations of hyperparameters.

Defining new starting points, chosen randomly, and starting points based on old hyperparameter tuning results provides a better balance in the hyperparameter search.

In particular, the hyperparameters that produced a good performance in a previous benchmark can be considered as promising hyperparameters for the new benchmark. They can, therefore, be used as starting points for a search carried out by certain processes.

Subsequently, the method then comprises a step 22 of executing each search method. Each search method is executed from its respective starting search point, i.e., from its initial combination of hyperparameters.

The search methods are executed simultaneously to explore the search space for the same length of time. In particular, the processing unit executes the search methods in parallel.

For example, if the processing unit has a plurality of cores, each core can execute a search method in parallel with the other cores. For example, a first core can execute a grid search method, a second core can execute a random search method, and a third core can execute an adaptive search method.

Each search method is used to test points in the search space. Each search method is, therefore, used to test different combinations of hyperparameters corresponding to points in the search space.

Each process is configured to keep, in an associated history, the results (SRES) of the hyperparameter combination tests that it performs.

In addition, the results (SRES) of the hyperparameter combination tests are also shared among the processes.

In particular, the results (SRES) of the tests are stored in a shared memory (SMEM), in a database, or in a file system to reuse them later.

Each process is designed to provide read access to the memory to read the tests already performed by the other processes. In particular, when a process defines a new combination of hyperparameters to be tested, this process is designed to check whether this new combination of hyperparameters has already been tested. If the new combination of hyperparameters has already been tested, the process does not repeat the test of this combination of hyperparameters but considers the test result in its test history. This helps speed up each hyperparameter search method.

More specifically, the results of each test are stored in memory with an identifier. This identifier is calculated based on the combination of hyperparameters associated with this test. For example, the identifier can correspond to the result of a hash function applied to the combination of hyperparameters.

Thus, before testing a new combination of hyperparameters, each process is designed to apply a hash function to this new combination of hyperparameters and to compare the result of this hash function with the identifiers of the results of the tests stored in memory. If the hash function result corresponds to an identifier stored in memory, another process has already tested the new combination of hyperparameters.

Furthermore, the results of the tests stored in memory can also be reused when the method for tuning hyperparameters is carried out again in a new benchmark.

Some processes execute search methods independently of other search methods, i.e., they do not consider the results stored from tests carried out by the other processes to search for a new combination of hyperparameters at each iteration. These processes are configured to carry out an independent search method chosen from a grid search method, a random search method, and an adaptive search method.

However, the processing unit executes an additional process designed to consider the results of the searches carried out by the other processes. Thus, this additional process is designed to analyze all of the results of the other processes to define the combination of hyperparameters to be tested at each iteration. In particular, the additional process is designed to perform an adaptive search, taking as input all of the results of the other processes to define each combination of hyperparameters to be tested.

To consider the results of the searches performed by the other processes, this additional process is designed for read access to the results stored in memory by the other processes.

Such an additional process increases the chances of achieving optimum overall performance more quickly. In addition, such an additional process can be executed in parallel with the other processes and, therefore, does not need additional time for the hyperparameter test.

The additional process makes it possible to perform a hyperparameter search with a broader vision of the search space, considering all of the results of the tests performed by the other processes. This helps to reduce the risk of finding a local optimum in the search space and instead search for a global optimum in the search space.

What is claimed is:

1. A method for tuning hyperparameters in a machine learning model, the method comprising:
executing, by a computer system having a processing unit configured to execute a plurality of processes in parallel, a plurality of independent hyperparameter search methods in different parallel processes of the processing unit, wherein each independent search method progressively tests different combinations of hyperparameters and maintains a history of each test;
storing results of the tests of the combinations of hyperparameters in a shared memory of the computer system accessible by the plurality of processes;
assessing, by each process before testing a combination of hyperparameters, whether the combination of hyperparameters has already been tested by another process based on the results of tests stored in the shared memory; and
incorporating, by each process, the results of tests stored in the shared memory into its own test history in response to determining that the combination of hyperparameters has already been tested.

2. The method of claim 1, further comprising executing a global hyperparameter search method in an additional process in parallel with executing the independent hyperparameter search methods, wherein the global search method progressively tests different combinations of hyperparameters, maintains a history of each test, and utilizes all the results of the tests stored in the shared memory to define a new combination of hyperparameters to test.

3. The method of claim 1, wherein the processing unit comprises a plurality of processing cores, and wherein the processes are executed by the plurality of processing cores to carry out the various hyperparameter search methods.

4. The method of claim 1,
wherein each search method for a combination of hyperparameters includes an initial step of defining an initial combination of hyperparameters, and
wherein the initial combination of hyperparameters is defined randomly for at least one search method.

5. The method of claim 1, wherein the plurality of independent hyperparameter search methods comprises a random search method, a grid search method, an adaptive search method that utilizes the results of tests of its history to determine a new combination of hyperparameters to test, or a combination thereof.

6. The method of claim 1, wherein the results of each hyperparameter combination test are stored in the shared memory with an identifier, the identifier being calculated based on the combination of hyperparameters associated with the test.

7. The method of claim 6, wherein, before testing a new combination of hyperparameters, each process:
calculates an identifier based on the new combination of hyperparameters;
compares the identifier with the identifiers of the results of the tests stored in the shared memory; and
determines that the new combination of hyperparameters has already been tested by another process based on the identifier of the new combination of hyperparameters corresponding to an identifier stored in the shared memory.

8. A method for tuning hyperparameters in a machine learning model, the method comprising:
executing, by a computer system having a processing unit configured to execute a plurality of processes in parallel, a plurality of independent hyperparameter search methods in different parallel processes of the processing unit;
executing a global hyperparameter search method in an additional process in parallel with executing the independent hyperparameter search methods, wherein each independent search method and the global search method progressively test different combinations of hyperparameters and maintain a history of each test; and
storing results of the tests of the combinations of hyperparameters in a shared memory of the computer system accessible by the plurality of processes,
wherein the global search method utilizes all of the results of the tests stored in the shared memory to determine a new combination of hyperparameters to test, and
wherein each process, before testing a combination of hyperparameters, assesses whether the combination of hyperparameters has already been tested by another process based on the results of tests stored in the shared memory.

9. The method of claim 8, wherein the global hyperparameter search method is an adaptive search method that utilizes all of the results of the tests stored in the shared memory to determine a new combination of hyperparameters to test.

10. The method of claim 8, wherein the results of each hyperparameter combination test are stored in the shared memory with an identifier, the identifier being calculated based on the combination of hyperparameters associated with the test.

11. The method of claim 10, wherein, before testing a new combination of hyperparameters, each process:
calculates an identifier based on the new combination of hyperparameters;
compares the identifier with the identifiers of the results of the tests stored in the shared memory; and
determines that the new combination of hyperparameters has already been tested by another process based on the identifier of the new combination of hyperparameters corresponding to an identifier stored in the shared memory.

12. The method of claim 11, wherein the identifier of a combination of hyperparameters is calculated by applying a hash function to the combination of hyperparameters.

13. The method of claim 8, wherein the plurality of independent hyperparameter search methods comprises a random search method, a grid search method, an adaptive search method, or a combination thereof.

14. The method of claim 13, wherein the adaptive search method utilizes the results of tests of its history to determine a new combination of hyperparameters to test.

15. A computer system for tuning hyperparameters in a machine learning model, the computer system comprising:
a non-transitory computer-readable memory storage comprising instructions;
a shared memory; and
a processing unit configured to execute a plurality of processes in parallel, the processing unit in communication with the non-transitory computer-readable memory storage and the shared memory, the instructions, the processing unit executing the instructions to:
execute a plurality of independent hyperparameter search methods in different parallel processes of the processing unit,
store results of tests of combinations of hyperparameters in the shared memory, wherein each independent search method progressively tests different combinations of hyperparameters and maintains a history of each test,
assess, by each process before testing a combination of hyperparameters, whether the combination of hyperparameters has already been tested by another process based on the results of tests stored in the shared memory, and
incorporate, by each process, the results of tests stored in the shared memory into its own test history for combinations of hyperparameters previously tested by other processes.

16. The computer system of claim 15, wherein the instructions further cause the computer system to execute a global hyperparameter search method in an additional process in parallel with executing the independent hyperparameter search methods, wherein the global search method progressively tests different combinations of hyperparameters, maintains a history of each test, and utilizes all the results of the tests stored in the shared memory to define a new combination of hyperparameters to test.

17. The computer system of claim 15, wherein the processing unit comprises a plurality of processing cores, and wherein the processes are executed by the plurality of processing cores to carry out the various hyperparameter search methods.

18. The computer system of claim 15, wherein the plurality of independent hyperparameter search methods comprises a random search method, a grid search method, an adaptive search method, or a combination thereof.

19. The computer system of claim 15, wherein the results of each hyperparameter combination test are stored in the shared memory with an identifier, the identifier being calculated based on the combination of hyperparameters associated with the test.

20. The computer system of claim 19, wherein, before testing a new combination of hyperparameters, each process:
calculates an identifier based on the new combination of hyperparameters by applying a hash function to the combination of hyperparameters;
compares the identifier with the identifiers of the results of the tests stored in the shared memory; and
determines that the new combination of hyperparameters has already been tested by another process based on the identifier of the new combination of hyperparameters corresponding to an identifier stored in the shared memory.
